(19) United States
(12) Patent Application Publication
(10) Pub. No.: US 2010/0015716 A1
(43) Pub. Date: Jan. 21, 2010

(54) METHOD FOR OIL DILUTION RATIO EVALUATION THROUGH RADIOACTIVITY MEASUREMENT

(76) Inventor: Bertrand Lecointe, Triel Sur Seine (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/305,216

(22) PCT Filed: Jun. 20, 2007
(86) PCT No.: PCT/FR07/01019

§ 371 Date: Jun. 1, 2009

(30) Foreign Application Priority Data
Jun. 22, 2006 (FR) 0605602

(51) Int. Cl. G01N 23/00

(52) U.S. Cl. 436/57

(57) ABSTRACT

The present invention relates to a method for evaluating the dilution ratio of the lubricating oil of an internal-combustion engine operating with a fuel containing at least part of at least one biofuel, wherein the radioactivity of an oil sample is measured so as to subsequently evaluate the ratio of dilution of the oil by the fuel.

According to the invention, this method consists in measuring the radioactivity of at least one of the constituents of the biofuel contained in the oil sample.

### FIELD OF THE INVENTION

The present invention relates to a method for evaluating the ratio of dilution of lubricating oil by the fuel of an internal-combustion engine.

An internal-combustion engine generally comprises a closed lubricating oil circulation circuit including an oil sump arranged in the lower part of the engine block, an oil circulation pump for circulating, through lines, the oil contained in this sump towards various moving parts to be lubricated, such as the crankshaft and camshaft bearings, or the piston-piston ring-cylinder unit.

The main purpose of this lubricating oil is to facilitate the relative motion between two parts of the engine by interposing a liquid film between these two parts. This notably allows friction between them to be minimized.

In the case of a piston-piston ring-cylinder unit of an engine, a thin oil film must be continually present between the outer surface of the piston and the wall of the cylinder so as to facilitate the rectilinear reciprocating motion of the piston in the cylinder. Absence or breaking of this oil film causes solid/solid contact that increases wear of the parts and risks of severe engine degradation.

This is even more worrying with new engine types, notably diesel engines, with exhaust gas post-treatment. In this type of engine, the fuel injection strategies are such that part of the fuel injected is projected onto the oil film present in the cylinder, which leads to wash out the cylinder wall and therefore the oil film, or at least causes the fuel to migrate towards the oil sump under the effect of the successive reciprocating motions of the piston and under the action of the piston rings.

This oil dilution significantly degrades the properties of the oil.

Notably, the viscosity of the oil decreases as a result of fuel addition, which notably causes degradation of the shear strength of the oil film. Furthermore, other properties, such as the anti-wear or dispersion or extreme pressure properties, are also degraded due to the dilution, by the fuel, of the additives present in the oil.

It is therefore necessary to be able to know the dilution ratio of this oil so as to act upon the operating parameters of the engine, notably the fuel injection strategies in order to prevent or to limit this dilution phenomenon.

### BACKGROUND OF THE INVENTION

Several known methods such as viscosity comparison of an oil sample taken from the engine and of a reference sample or chromatographic methods allow this dilution to be evaluated.

Document WO-2005/071,403 discloses measurement of the radioactivity of a short-life radioactive tracer that has been fed into the oil or the fuel beforehand, during engine operation. This measurement of the radioactivity difference measured in the lubricating oil taken from the engine thus allows to deduce the amount of fuel contained in the sample and, by simple calculation, to obtain the ratio of oil dilution by the fuel.

Such an evaluation method, although satisfactory, however involves drawbacks that are not insignificant.

In fact, a radioactive tracer has to be fed into the oil or the fuel with very specific characteristics that are close to the product to be traced. Furthermore, these radioactive elements, when used in large amounts, must meet very stringent laws and standards as regards their storage and handling. Besides, these tracers, whose cost is by no means insignificant, require resupplying upon each oil change or fuel tank filling.

The present invention aims to overcome the aforementioned drawbacks by means of a method allowing to evaluate the ratio of dilution of the oil by the fuel without addition of any specific tracer and to subsequently envisage possible injection strategy changes so as to be able to control this dilution.

### SUMMARY OF THE INVENTION

The present invention thus relates to a method for evaluating the dilution ratio of the lubricating oil of an internal-combustion engine operating with a fuel containing at least part of at least one biofuel, wherein the radioactivity of an oil sample is measured so as to subsequently evaluate the ratio of dilution of the oil by the fuel, characterized in that it consists in measuring the radioactivity of at least one of the constituents of the biofuel contained in the oil sample.

This method can consist in measuring the radioactivity of said at least one constituent of the biofuel comprising a radioactive element with a half life above 5000 years.

It can consist in measuring the radioactivity of the carbon isotope (¹⁴C) contained in the biofuel.

Advantageously, the fuel can comprise only biofuel.

The method can also consist in adding at least one biofuel to the fuel during the dilution ratio evaluation operation.

Other features and advantages of the invention will be clear from reading the description hereafter.

### DETAILED DESCRIPTION

Usually, the fuel used for the combustion of an internal-combustion engine is a fossil fuel that comprises no radioactive elements.

Considering the problems linked with the shortage risk of energy of petroleum origin and with the atmospheric pollution increase, an increasingly large proportion of such fossil fuels comprises a quite significant amount of one or more biofuels.

These biofuels are obtained either from oil crops, such as colza and sunflower (biofuel referred to as vegetable oil methyl ester) or sugar cane and beet (methanol-based or ethanol-based biofuel), or from biomass.

Currently, up to approximately 5% in energy equivalent of at least one biofuel can be incorporated in a fossil fuel, such as diesel fuel. It is also admitted that, in some countries such as Brazil, internal-combustion engines operate with pure biofuels such as alcohol obtained from sugar cane for example.

Pure biofuels or fossil fuels comprising a biofuel part therefore contain carbon 14 (¹⁴C) from the vegetable material used for the production of biofuel and whose half life is 5570 years.

One takes advantage of the presence of this ¹⁴C by using it as a natural radioactive tracer in order to estimate the ratio of dilution of the oil by the fuel.

Thus, in order to be able to evaluate the ratio of dilution of the oil by the fuel, an oil sample is taken in the oil sump of the engine. This sampling can be done punctually or continuously by means of a lubricating circuit bypass line during engine operation.

This sample is subjected to an ionizing radiation detector that picks up and measures the radiation emitted by the ¹⁴C contained in the oil of the sample. The signals emitted by the detector are then sent to a computing unit that evaluates the ratio of dilution of the oil by the fuel. This evaluation is carried out either from charts or data contained in this computing unit, or by comparison with a sample of pure oil, i.e. without oil dilution by the fuel.

If this evaluation is performed continuously by diverting a proportion of oil from the operating engine, then by reinjecting it into the lubricating circuit after measurement, a first radiation measurement of the sample can be advantageously carried out, then other radiation measurements can be carried out regularly. The time interval between each measurement will be of the order of some seconds to some ten seconds, depending on the extent of the dilution phenomenon. After these measurements, the radioactivity increase is determined, as well as, by calculation, the proportion of fuel incorporated in the sample and, consequently, the ratio of dilution of the oil by the fuel.

This allows a higher evaluation reliability to be reached as regards the ratio of dilution of the oil by the fuel.

Of course, the present invention is not limited to the embodiment described above by way of example and it encompasses any variant and equivalent.

Thus, one can consider incorporating this ¹⁴C as a natural radioactive tracer by adding it, in form of an additive, to the basic fossil fuel that does not contain any initially when it is desired to carry out a punctual evaluation of the oil dilution ratio.

1) A method for evaluating the dilution ratio of the lubricating oil of an internal-Pcombustion engine operating with a fuel containing at least a biofuel part, wherein the radioactivity of an oil sample is measured so as to subsequently evaluate the ratio of dilution of the oil by the fuel, characterized in that it consists in carrying out at least one measurement of the radioactivity of at least one of the constituents of the biofuel contained in the oil sample.

2) A method for evaluating the dilution ratio of the lubricating oil as claimed in claim 1, characterized in that it consists in measuring the radioactivity of said at least one constituent of the biofuel comprising a radioactive element with a half life above 5000 years.

3) A method for evaluating the dilution ratio of the lubricating oil as claimed in claim 1, characterized in that it consists in measuring the radioactivity of the carbon isotope (¹⁴C) contained in the biofuel.

4) A method for evaluating the dilution ratio of the lubricating oil as claimed in claim 1, characterized in that the fuel comprises only biofuel.

5) A method for evaluating the dilution ratio of the lubricating oil as claimed in claim 1, characterized in that it consists in adding at least one biofuel to the fuel during the dilution ratio evaluation operation.
